(19) United States
(12) Patent Application Publication
(10) Pub. No.: US 2013/0152119 A1
(43) Pub. Date: Jun. 13, 2013

(54) METHOD AND APPARATUS FOR INTERWORKING DEVICES

(71) Applicant: KT CORPORATION, Seongnam (KR)

(72) Inventors: Young-Woo CHOI, Daejeon (KR); Min-Jeong KANG, Daejeon (KR); Seung-Tak LEE, Daejeon (KR); Dong-Hyuck IM, Daejeon (KR)

(73) Assignee: KT CORPORATION, Seongnam (KR)

(21) Appl. No.: 13/709,825

(22) Filed: Dec. 10, 2012

(30) Foreign Application Priority Data
Dec. 8, 2011 (KR) 10-2011-0130911

(51) Int. Cl. H04N 21/436; H04N 21/4367

(52) U.S. Cl. CPC H04N 21/43615; H04N 21/4367
USPC 725/25; 725/80

(57) ABSTRACT

An interworking service method includes receiving, from an interworking service providing server, a registration request for registering an interworking requesting device and an interworking service that is to be provided by the interworking service providing server, registering information about the interworking requesting device and information about the interworking service in response to the registration request, receiving, from the interworking service providing server, an interworking request including the information about the interworking requesting device and the information about the interworking service and interworking the interworking target device with the interworking requesting device if the information about the interworking requesting device and the information about the interworking service included in the interworking request match with the registered information about the interworking requesting device and the registered information about the interworking service.

### CROSS-REFERENCE TO RELATED PATENT APPLICATION

This application claims the benefit of priority from the Korean Patent Application No. 10-2011-0130911, filed on Dec. 8, 2011 in the Korean Intellectual Property Office, the entire disclosure of which is incorporated herein by reference in its entirety.

### BACKGROUND

1. Field

Exemplary embodiments broadly relate to a method and an apparatus for interworking devices, and more specifically, exemplary embodiments relate to a method and an apparatus for interworking devices by authenticating a service request device and an interworking service.

2. Description of the Related Art

As various devices which are equipped with various operating systems, are becoming widely use, applications for providing various services are being increasingly developed. Various applications for providing services that take advantage of an interactivity of IPTVs or smart TVs as well as mobile devices are being developed.

In a related art, there is a service for providing increased convenience for the user by interworking a user's device with another device such as a TV, for example, by controlling a TV with a device such as a smartphone and a tablet PC or by transmitting contents to a TV from a device such as a smartphone and a tablet PC.

Korean Patent Laid-open Publication No. 2003-0026134 describes that a remote control unit transmits its own identifier (ID) and a control signal to a display device and when the ID is identical to a preset ID, the display device controls its functions in response to the control signal. Korean Patent No. 0547870 describes that a remote control device has control codes for usage authentication of a plurality of control target apparatuses and when transmitting a control signal to a specific control target apparatus, the remote control device also transmits a control code for usage authentication i.e., to carry out usage authentication.

However, if two different devices are interworked with each other without authentication in an external service, pernicious information such as spam ads may be exposed on a screen of a device or unintended controls of the devices may be illegally made illegally, which may cause inconvenience to the user.

### SUMMARY

Accordingly, it is an aspect to provide a method and an apparatus in which authentication for devices that request interworking services and requested interworking services are carried out and only devices and services registered by a user of an interworking target device are allowed to be interworked with the interworking target device.

According to an aspect of exemplary embodiments, there is provided a method performed by an interworking target device. The method includes receiving, from an interworking service providing server, a registration request for registering an interworking requesting device and an interworking service that is to be provided by the interworking service providing server, registering information about the interworking requesting device and information about the interworking service in response to the registration request, receiving, from the interworking service providing server, an interworking request including the information about the interworking requesting device and the information about the interworking service and interworking the interworking target device with the interworking requesting device if the information about the interworking requesting device and the information about the interworking service included in the interworking request matches with the registered information about the interworking requesting device and the registered information about the interworking service.

According to another aspect of exemplary embodiments, there is provided a method performed by an interworking service providing server. The method includes receiving, from an interworking request device, a registration request of the interworking requesting device for an interworking service, registering information about the interworking requesting device and the interworking service in response to the registration request, transmitting, to an interworking target device, a registration request for registering the interworking requesting device and the interworking service, authenticating the interworking request device in response to receiving the registration request from the interworking requesting device, and providing the interworking service to the interworking requesting device and the interworking target device if the authentication for the interworking requesting device is successful.

According to another aspect of exemplary embodiments, an interworking target device includes a registration request receiver configured to receive, from an interworking service providing server, a registration request for registering an interworking requesting device and an interworking service that is to be provided by the interworking service providing server, an interworking information manager configured to register information about the interworking requesting device and information about the interworking service in response to the registration request, an interworking request receiver configured to receive, from the interworking service providing server, an interworking request including the information about the interworking requesting device and information about the interworking service, an interworking authenticator configured to determine whether the information about the interworking requesting device and the information about the interworking service included in the interworking request matches with the registered information about the interworking requesting device and the registered information about the interworking service and an interworking service provider configured to interwork the interworking target device with the interworking requesting device if the information about the interworking requesting device and the information about the interworking service included in the interworking request matches with the registered information about the interworking requesting device and the registered information about the interworking service.

In exemplary embodiments, it is determined whether a device that requests interworking service is registered with a requested interworking service and only a device and a service registered by a user of an interworking target device are allowed to be interworked with the interworking target device, and, thus, it is possible to prevent an interwork between a user device and an unintended device or service.

### BRIEF DESCRIPTION OF THE DRAWINGS

Non-limiting and non-exhaustive exemplary embodiments will be described in conjunction with the accompanying drawings. Understanding that these drawings depict only exemplary embodiments and are, therefore, not to be intended to limit its scope, the exemplary embodiments will be described with specificity and detail taken in conjunction with the accompanying drawings, in which:

FIG. 1 is a view illustrating a configuration of an interworking service system according to an exemplary embodiment;

FIG. 2 is a flow diagram illustrating an interworking method according to an exemplary embodiment;

FIG. 3 is a block diagram illustrating an interworking service providing server according to an exemplary embodiment; and

FIG. 4 is a block diagram illustrating an interworking target device according to an exemplary embodiment.

### DETAILED DESCRIPTION OF EXEMPLARY EMBODIMENTS

Hereinafter, exemplary embodiments will be described in detail with reference to the accompanying drawings to be readily implemented by those skilled in the art. However, it is to be noted that the present disclosure is not limited to the exemplary embodiments, but can be realized in various other ways. In the drawings, certain parts not directly relevant to the description of exemplary embodiments are omitted to enhance the clarity of the drawings, and like reference numerals denote like parts throughout the whole document.

Throughout the whole document, the terms “connected to” or “coupled to” are used to designate a connection or coupling of one element to another element, and include both a case where an element is “directly connected or coupled to” another element and a case where an element is “electronically connected or coupled to” another element via still another element. Further, each of the terms “comprises,” “includes,” “comprising,” and “including,” as used in the present disclosure, is defined such that one or more other components, steps, operations, and/or the existence or addition of elements are not excluded in addition to the described components, steps, operations and/or elements.

Hereinafter, exemplary embodiments will be explained in detail with reference to the accompanying drawings.

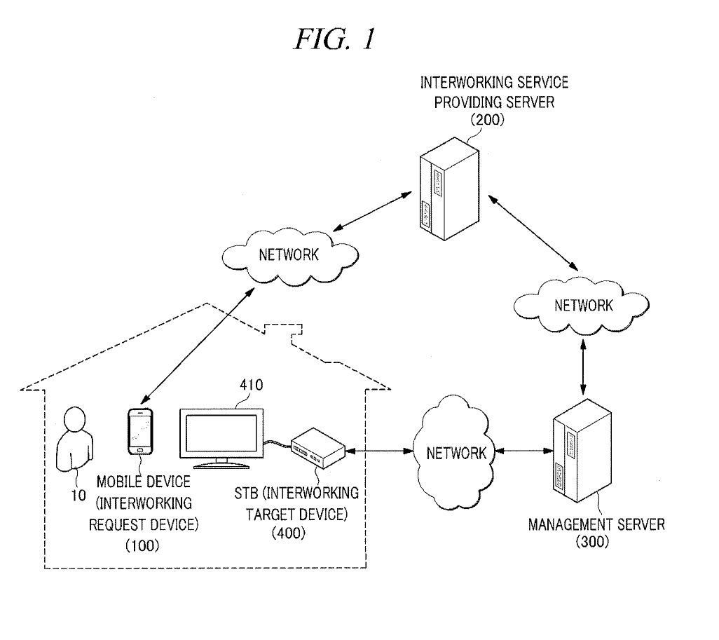

FIG. 1 is a view illustrating a configuration of an interworking service system according to an exemplary embodiment.

In an exemplary embodiment, an interworking request device such as a mobile device 100 and an interworking target device such as a set-top box 400 may be interworked with each other to provide an interworking service to a user 10. By way of example, the user 10 may select a menu displayed on a display apparatus such as a TV 410 or input specific words through the set-top box 400 by using the mobile device 100.

In order to do so, the mobile device 100 makes a registration request for an interworking service in order to register the mobile device 100 as a device to be interworked with the set-top box 400. The mobile device 100 may transmit the registration request to the interworking service providing server 200 by using an application contained in the mobile device 100.

Further, the mobile device 100 may transmit an interworking request to the interworking service providing server 200 in order to receive an interworking service with respect to the set-top box 400.

The interworking service providing server 200 matches and registers the mobile device 100 with an interworking service that is to be provided by the interworking service providing server 200 in response to the registration request received from the mobile device 100.

The interworking service providing server 200 transmits, to a management server 300, a registration request including information about the mobile device and the interworking service for registering the mobile device 100. The mobile device 100 and the interworking service are matched with each other, and are then registered at the set-top box 400.

Further, the interworking service providing server 200 determines whether the mobile device 100 is registered with the interworking service if the interworking request is received from the mobile device 100. If the mobile device 100 is registered with the interworking service in the interworking service providing server 200, the interworking service providing server 200 transmits, to the management server 300, an interworking request including mobile device information and the interworking service information with respect to the set-top box 400.

The management server 300 searches its storage for an address, e.g. an IP address, of a registration target, i.e. the set-top box 400, in response to the registration request received from the interworking service providing server 200 and transmits the registration request to the set-top box 400 using the found address.

Further, the management server 300 searches for an address of the set-top box 400 as a target of an interworking service requested by the interworking service providing server 200 in response to the interworking request received from the interworking service providing server 200 and transmits the interworking service execution request to the set-top box 400 at the found address.

The set-top box 400 registers the mobile device information 100 and the interworking service included in the registration request as a device and as a service to be interworked with the set-top box 400 in response to the registration request received from the management server 300.

Further, the set-top box 400 determines whether mobile device information and interworking service information included in the interworking request are identical to the registered information about the mobile device and about the interworking service in response to the interworking request received from the management server 300. If the mobile device information and the interworking service information included in the interworking request are identical to the registered information about the mobile device and about the interworking service, the set-top box 400 interworks with the mobile device 100.

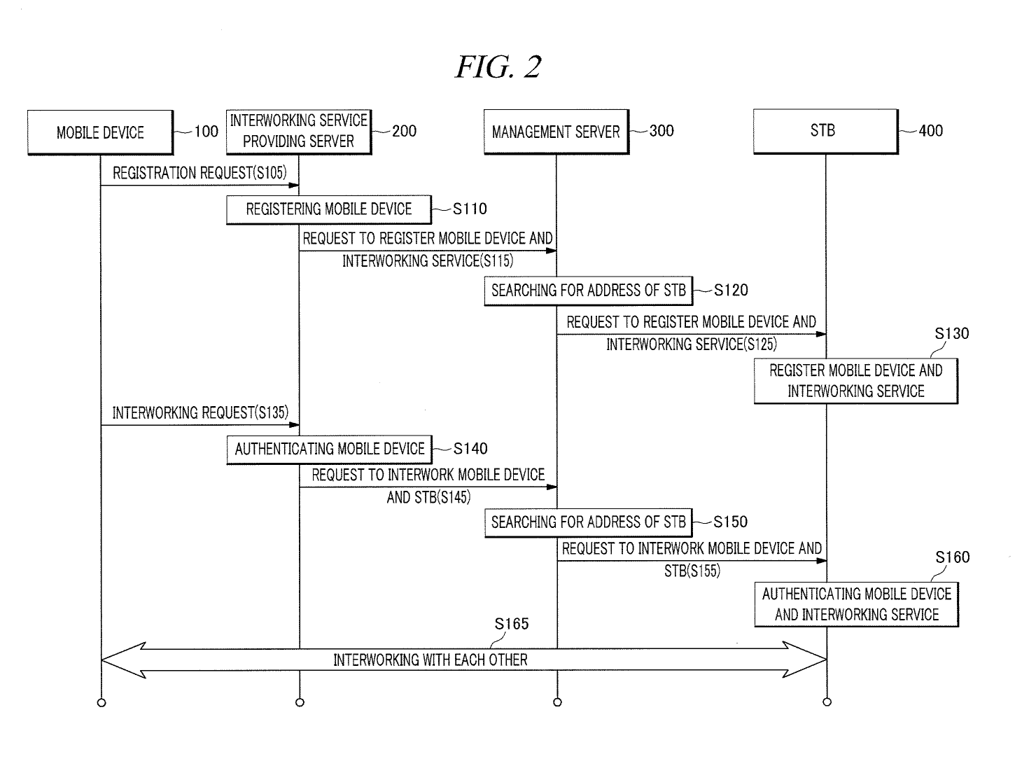

FIG. 2 is a flow diagram illustrating an interworking method according to an exemplary embodiment.

In operation S105, in order to interwork the mobile device 100 with the set-top box 400, the mobile device 100 makes a registration request for registering the mobile device 100 for an interworking service and transmits the registration request to the interworking service providing server 200.

The mobile device 100 may transmit information about the set-top box 400 to the interworking service providing server 200 together with the registration request from the mobile device 100. The mobile device 100 may acquire the information about the set-top box 400 from information input by the user into the mobile device 100.

By way of example, the user may acquire identification information of the set-top box 400 for an interworking service by using an application installed in the set-top box 400 and may input the acquired identification information about the set-top box 400 into the mobile device 100.

In operation S110, the interworking service providing server 200 registers the requesting mobile device 100 and an interworking service that is to be provided by the interworking service providing server 200 in response to the registration request received in operation S105. The interworking service providing server 200 stores and manages identification information, e.g. ID, of the mobile device 100 with respect to the interworking service.

In operation S115, the interworking service providing server 200 makes a request for registering the mobile device 100 with respect to the set-top box 400 and with respect to the interworking service that is to be provided by the interworking service providing server 200 to the management server 300.

The interworking service providing server 200 may not manage information regarding an address, e.g. an IP address, of the set-top box 400. Thus, the interworking service providing server 200 may request a registration of the mobile device 100 and the interworking service from the management server 300 that manages the set-top box 400.

Therefore, the interworking service providing server 200 may transmit a registration request including information about the mobile device 100 and information about the interworking service, and information about the set-top box 400 to the management server 300.

In operation S120, the management server 300 searches for an address of the set-top box 400 by using the information about the set-top box 400 received with or in the registration request.

In operation S125, the management server 300 transmits the request to register the mobile device 100 and the interworking service to the set-top box 400 at the address of the set-top box 400 searched in operation S120.

In operation S130, the set-top box 400 registers the interworking service that is to be provided by the interworking service providing server 200 and registers the mobile device 100 that is to be interworked with the set-top box 400 in response to the registration request received in operation S125.

The set-top box 400 displays the information about the mobile device 100 as an interworking requesting device and the information of the interworking service using a display apparatus, for example, a TV screen, connected with the set-top box 400 to ask whether the user permits the registration of the mobile device.

After the user checks the provided information of the mobile device 100 and interworking service, if the user grants permission for registration i.e., by inputting data (permission) into the set-top box 400, the set-top box 400 may register the mobile device 100 and the interworking service as a device to be interworked with the set-top box 400 and as an interworking service to be executed between the mobile device 100 and the set-top box 400.

In operation S135, the mobile device 100 transmits an interworking request including mobile device information and interworking service information to the interworking service providing server 200. The mobile device 100 may transmit the mobile device information 100 and the information about the set-top box 400 to the interworking service providing server 200 together with an interworking request.

In operation S140, the interworking service providing server 200 checks whether the mobile device 100 that transmitted the interworking request is registered with respect to the interworking service, in response to the interworking request received in operation S135, to authenticate the mobile device 100.

In operation S145, if the mobile device 100 is authenticated as the registered device with respect to the interworking service in operation S140, the interworking service providing server 200 forwards the interworking request of the mobile device 100 to the management server 300. In an exemplary embodiment, the interworking service providing server 200 may generate its own interworking request if the mobile device 100 is authenticated. The interworking request of the interworking service providing server 200 will identify the mobile device 100 and the corresponding STB 400 as well as the requested interworking service e.g., a particular function for the STB 400 to perform as requested by the mobile device 100.

As described above, the interworking service providing server 200 may not be the one that manages an address of the set-top box 400. Thus, the interworking service providing server 200 may send a request for the interworking service between the mobile device 100 and the set-top box 400 to the management server 300 that manages the set-top box 400.

In operation S150, the management server 300 searches for an address of the set-top box 400 by using the information about the set-top box 400 received with the interworking request.

In operation S155, the management server 300 forwards the interworking request of the mobile device 100 to the set-top box 400 at the address of the set-top box 400 found in operation S150. In an exemplary embodiment, the management server 300 may generate its own interworking request. The interworking request of the management server 300 will identify the mobile device 100 as well as the requested interworking service e.g., a particular function for the STB 400 to perform as requested by the mobile device 100.

In operation S160, the set-top box 400 determines whether the mobile device information and the interworking service information included in the interworking request is identical to the registered information of the mobile device and the interworking service, to authenticate the mobile device 100 and the interworking service.

In operation S165, if the mobile device 100 that transmitted an interworking request and the requested interworking service are determined as a device and as an interworking service registered with respect to the set-top box 400 in operation S160, the set-top box 400 provides the interworking service which is executed between the mobile device 100 and the set-top box 400.

Therefore, if the user generates a control signal for the set-top box 400 by using the mobile device 100, the generated control signal is transmitted to the set-top box 400 via the interworking service providing server 200 and the set-top box 400 is controlled in response to the control signal.

Further, if the mobile device 100 that transmitted the interworking request and the requested interworking service are determined as a device and as an interworking service registered with respect to the set-top box 400 in operation S160, the set-top box 400 may display the mobile device information and the interworking service information using a display apparatus such as a TV to ask whether the user permits the interworking services, allows the interworking request.

Further, in the above-described exemplary embodiment, although it has been explained that the registration request and the interworking request are made by the mobile device 100, this is provided by way of an example only and not by way of a limitation. The registration request with respect to the mobile device 100 can be made by the set-top box 400 and the interworking request with respect to the mobile device 100 can also be made by the set-top box 400. In other words, in an exemplary embodiment, the registration requests and the request to provide the interwork service may originate from the set-top box 400 as opposed to the mobile device 100. Further, although in an exemplary embodiment, the set-top box 400 is controlled by the mobile device 100, it is possible that the set-top box 400 is used to control the mobile device 100 by an analogous method to the one described above.

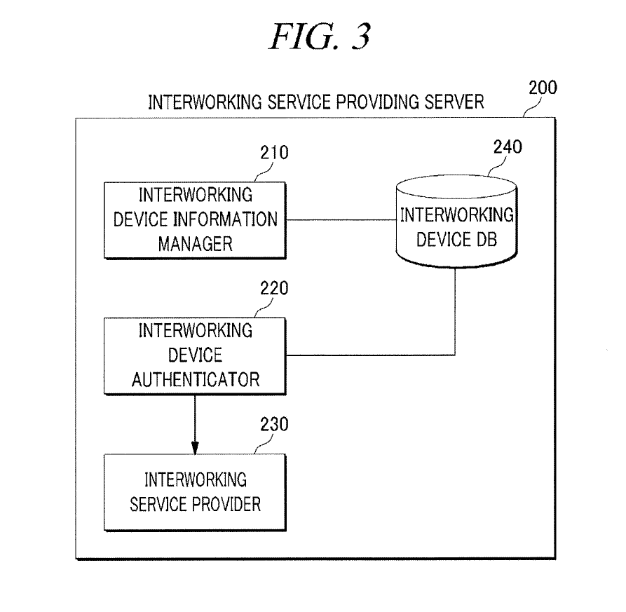

FIG. 3 is a block diagram illustrating an interworking service providing server according to an exemplary embodiment.

The interworking service providing server 200 according to an exemplary embodiment includes an interworking device information manager 210, an interworking device authenticator 220, an interworking service provider 230, and an interworking device database 240. In an exemplary embodiment, one or more of the interworking device information manager 210, the interworking device authenticator 220, the interworking service provider 230, and the interworking device database 240 may include a hardware component or a hardware circuitry. In yet another exemplary embodiment, the device information manager 210, the interworking device authenticator 220, and the interworking service provider 230 may be executed by a processor of the interworking service providing server 200. The interworking device database may be stored on a memory of the interworking service providing server 200.

The interworking device information manager 210 receives a registration request for an interworking service from a mobile device 100 or a set-top box 400 and matches information about the mobile device 100 with an interworking service and stores them at the interworking device database 240.

The interworking service providing server 200 can provide one or more interworking services and the interworking device information manager 210 matches identification information about the mobile device 100 with an interworking service requested by the mobile device 100 and stores them at the interworking device database 240 to register the requested interworking service with the mobile device.

If the interworking device authenticator 220 receives a specific interworking request from the mobile device 100, the interworking device authenticator 220 determines whether the mobile device 100 is registered with respect to the requested specific interworking service in advance. If the mobile device 100 is determined to be unregistered, the request is denied.

If it is determined that the mobile device 100 that transmits the specific interworking request is registered with respect to the requested specific interworking service, the interworking device authenticator 220 instructs the interworking service provider 230 to generate and transmit the interworking request including mobile device information and interworking service information corresponding to the interworking service between the mobile device 100 and the set-top box 400 requested by the mobile device.

In response to an authentication result of the interworking device authenticator 220, the interworking service provider 230 transmits a request so that the set-top box may determine whether the mobile device 100 and the interworking service is an appropriately registered device and service in order to provide the interworking service.

As described above, by way of an example, the interworking service provider 230 can acquire identification information of the set-top box 400 instead of address information of the set-top box 400. In this case, the interworking service provider 230 can make a request to a management server 300 that manages the set-top box 400 to authenticate the interworking service and the requested specific interworking service by using the identification information of the set-top box 400.

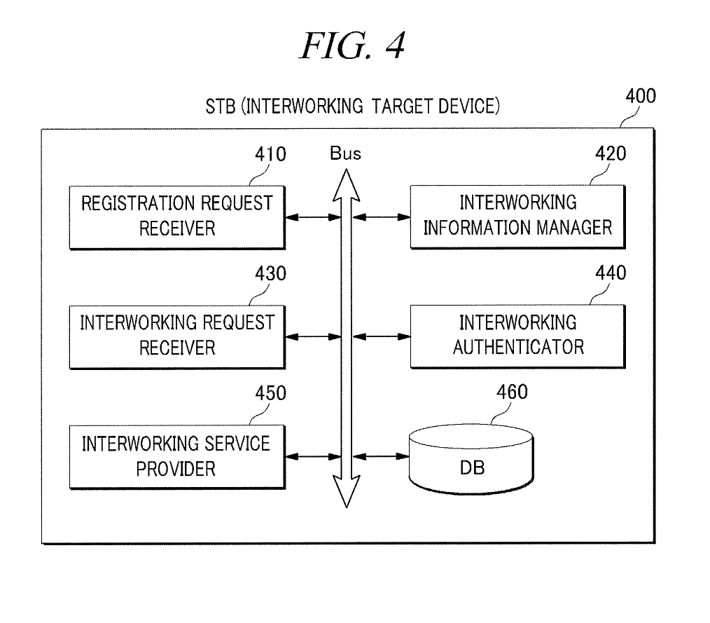

FIG. 4 is a block diagram illustrating an interworking target device according to an exemplary embodiment.

The interworking target device according to an exemplary embodiment may include the set-top box 400. The set-top box 400 according to an exemplary embodiment includes a registration request receiver 410, an interworking information manager 420, an interworking request receiver 430, an interworking authenticator 440, an interworking service provider 450, a database 460. In an exemplary embodiment, one or more of the registration request receiver 410, the interworking information manager 420, the interworking request receiver 430, the interworking authenticator 440, the interworking service provider 450, and the database 460 may include a hardware component or a hardware circuitry. In yet another exemplary embodiment, the device information manager 210, the interworking device authenticator 220, and the interworking service provider 230 may be executed by a processor of the interworking service providing server 200. The interworking device database may be stored on a memory of the interworking service providing server 200.

The registration request receiver 410 receives a registration request including information about the mobile device 100 and information about the interworking service to register a mobile device 100 and the interworking service. Further, in the above-described exemplary embodiment, although it has been explained that the registration request includes the information about the mobile device 100 and about the interworking service, this is provided by way of an example only and not by way of a limitation. That is, the registration request receiver 410 may receive information about the mobile device and about the interworking service together with the registration request.

The interworking information manager 420 provides information about the mobile device 100 to the user using a display apparatus, such as a TV, connected to the set-top box 400 in response to the registration request received by the registration request receiver 410. The interworking information manager 420 may ask the user about whether to register the mobile device 100 for interworking.

If it is confirmed (i.e., the user approves the request) that the mobile device 100 needs to be registered for the interworking, the interworking information manager 420 registers the mobile device 100 as an interworking request device with respect to the set-top box 400 and stores the registration information in the database 460.

The interworking information manager 420 provides information about the requested interworking service to the user using the display apparatus, such as a TV, connected to the set-top box 400 in response to the registration request received by the registration request receiver 410. The interworking information manager 420 may ask the user about whether to register the interworking service for interworking.

If it is confirmed that the interworking service needs to be registered for interworking, the interworking information manager 420 registers the interworking service that is to be interworked with respect to the set-top box 400 and stores the information in the database 460.

Although the information about the mobile device 100 and about the interworking service being registered by the interworking information manager 420 has been explained by way of an example, it is not limited thereto. The mobile device and the interworking service may be registered at the same time, and the interworking information manager 420 may be separated into an interworking device information manager and an interworking service information manager by a management target. In this case, the information of the mobile device 100 and the interworking service may be provided together using the display apparatus, such as a TV, the user may be asked about whether to register the mobile device and the interworking service, and the mobile device 100 and the interworking service may be registered at the same time.

The interworking request receiver 430 receives an interworking request including mobile device information and the interworking device of the interworking service from the interworking service providing server 200. Further, in the above-described exemplary embodiment, although it has been explained that the registration request includes the information about the mobile device 100 and the interworking service, this is provided by way of an example only and not by way of a limitation. That is, the interworking request receiver 430 may receive the mobile device information and the interworking service information together with the interworking request.

The interworking authenticator 440 determines whether the mobile device 100 is registered as an interworking request device with respect to the set-top box 400 by using the mobile device information received by the interworking request receiver 430. The interworking authenticator 440 acquires the information about the mobile device registered by the interworking information manager 420 from the database 460 and authenticates the mobile device 100 that requests the interworking service.

The interworking authenticator 440 determines whether the interworking service is matched with the mobile device 100 and registered as an interworking service to be interworked with respect to the set-top box 400 by using the interworking service information received by the interworking request receiver 430. The interworking authenticator 440 acquires the information about the interworking service registered by interworking information manager 420 from the database 460 and authenticates the interworking service.

Although there has been explained that the mobile device is authenticated and then the interworking service is authenticated by the interworking authenticator 440, this is provided by way of an example only and not by way of a limitation. The interworking authenticator 440 may determine together whether the mobile device and the interworking service match with each other and are registered as the interworking request device and the interworking service, respectively, with respect to the set-top box 400, and the interworking authenticator 440 may be separated into an interworking device authenticator and an interworking service authenticator by an authentication target.

If it is determined that the mobile device 100 and the interworking service are appropriate, the interworking service provider 450 executes the requested interworking service. Accordingly, the set-top box 400 can be provided with the interworking service from the interworking service provider (illustration omitted).

Therefore, the mobile device and the set-top box 400 can be interworked with each other. By way of example, input of an interworking service by the mobile device 100 may be applied to the set-top box 400 and may be output using a display apparatus such as a TV.

As described above, according to the exemplary embodiments, an interworking service providing server 200 determines whether the mobile device 100 that requests interworking service is matched with and registered with an interworking service to carry out a primary authentication and the set-top box 400 determines whether the mobile device 100 and the interworking service are matched with and registered with the set-top box 400 to carry out a secondary authentication, so that an external device cannot be provided an interworking service with the set-top box 400 when primary and/or secondary authentications fail.

Further, if an interworking requesting device, for example, the mobile device 100, requests an interworking service, an interworking target device, for example, the set-top box 400, not only authenticates the mobile device 100, but also determines whether the mobile device 100 is matched with and registered with the specific interworking service.

Exemplary embodiments may be embodied in a transitory or a non-transitory storage medium which includes instruction codes which are readable and executable by a computer or processor, such as a program module which is executable by the computer or processor. A data structure according to exemplary embodiments may be stored in the storage medium and executable by the computer or processor. A computer readable medium may be any usable medium which can be accessed by the computer and includes all volatile and/or non-volatile and removable and/or non-removable media. Further, the computer readable medium may include any or all computer storage and communication media. The computer storage medium may include any or all volatile/non-volatile and removable/non-removable media embodied by a certain method or technology for storing information such as, for example, computer readable instruction code, a data structure, a program module, or other data. The communication medium may include the computer readable instruction code, the data structure, the program module, or other data of a modulated data signal such as a carrier wave, or other transmission mechanism, and includes information transmission mediums.

The above description of exemplary embodiments is provided for the purpose of illustration, and it will be understood by those skilled in the art that various changes and modifications may be made without changing a technical conception and/or any essential features of exemplary embodiments. Thus, above-described exemplary embodiments are exemplary in all aspects, and do not limit the present disclosure. For example, each component described to be of a single type can be implemented in a distributed manner. Likewise, components described to be distributed can be implemented in a combined manner.

The scope of the present inventive concept is defined by the following claims and their equivalents rather than by the detailed description of exemplary embodiments. It shall be understood that all modifications and embodiments conceived from the meaning and scope of the claims and their equivalents are included in the scope of the present inventive concept.

What is claimed is:

1. A method performed by an interworking target apparatus, the method comprising:
receiving, from an interworking service providing server, a registration request for registering an interworking requesting device and an interworking service that is to be provided by the interworking service providing server;
registering information about the interworking requesting device and information about the interworking service in response to the registration request;
receiving, from the interworking service providing server, an interworking request including the information about the interworking requesting device and information about the interworking service; and
interworking the interworking target device with the interworking requesting device if the information about the interworking requesting device and the information about the interworking service included in the interworking request matches with the registered information about the interworking requesting device and the registered information about the interworking service.

2. The method of claim 1 further comprising:
displaying the information about the interworking requesting device and the information about the interworking service in response to the registration request; and
receiving a user input authorizing the registration request.

3. The method of claim 1, wherein the interworking the interworking target device with the interworking requesting device comprises:
receiving a user input that authorizes the interworking of the interworking target device with the interworking requesting device.

4. The method of claim 1, wherein the registration request and the interworking request are received from the interworking service providing server via a management server that manages an address of the interworking target device.

5. A method performed by an interworking service providing server, the method comprising:
receiving, from an interworking requesting device, a registration request requesting registration for an interworking service;
registering information about the interworking requesting device and the interworking service in response to the registration request;
transmitting, to an interworking target device, a registration request for registering the interworking requesting device and the interworking service;
authenticating the interworking requesting device in response to receiving the registration request from the interworking requesting device; and
providing the interworking service to the interworking requesting device and the interworking target device if the authentication for the interworking requesting device is successful.

6. The interworking method of claim 5, wherein the registration request for registering the interworking requesting device and the interworking service is transmitted to the interworking target device via a management server that manages an address of the interworking target device.

7. The interworking method of claim 6, wherein the providing the interworking service comprises:
transmitting an interworking request including information about the interworking requesting device and information about the interworking service to the interworking target device.

8. The interworking method of claim 7, wherein the interworking request is transmitted to the interworking target device via the management server.

9. An interworking target device comprising:
a registration request receiver configured to receive, from an interworking service providing server, a registration request for registering an interworking requesting device and an interworking service that is to be provided by the interworking service providing server;
an interworking information manager configured to register information about the interworking requesting device and information about the interworking service in response to the registration request received from the registration request receiver;
an interworking request receiver configured to receive, from the interworking service providing server, an interworking request including the information about the interworking requesting device and the information about the interworking service;
an interworking authenticator configured to determine whether the information about the interworking request device and information about the interworking service included in the interworking request matches with the registered information about the interworking requesting device and the registered information about the interworking service; and
an interworking service provider configured to interwork the interworking target device with the interworking requesting device if the information about the interworking requesting device and the information about the interworking service included in the interworking request matches with the registered information about the interworking requesting device and the registered information about the interworking service.

10. The device of claim 9, wherein the interworking information manager is configured to display the information about the interworking requesting device and the information about the interworking service in response to the registration request, and to receive a user input that authorizes the registration request in response to the display.

11. The device of claim 9, wherein the registration request and the interworking request are received from the interworking service providing server via a management server that manages an address of the interworking target device.

12. The method of claim 1, wherein the interworking target device comprises a set-top box and wherein the interworking requesting device comprises a mobile terminal.

13. The method of claim 2, wherein the information about the interworking requesting device and the information about the interworking service are displayed on a display of a display apparatus which is controlled by the interworking target device.

14. The method of claim 1, denying the interworking request if the information about the interworking requesting device and the information about the interworking service included in the interworking request does not match registered information about the interworking requesting device and registered information about the interworking service.

15. The interworking method of claim 5, further comprising denying the interworking service to the interworking requesting device if the authentication for the interworking requesting device fails.
